(19) United States
(12) Patent Application Publication
(10) Pub. No.: US 2023/0323136 A1
(43) Pub. Date: Oct. 12, 2023

(54) INFRARED RADIATION SLURRY AND INFRARED RADIATION HEATING ELEMENT BASED ON SAME

(71) Applicant: CHINA TOBACCO ANHUI INDUSTRIAL CO., LTD., Hefei (CN)

(72) Inventors: Jin ZHANG, Hefei (CN); Yun Cao, Hefei (CN); Shun Zhou, Hefei (CN); Xiaofeng Wang, Hefei (CN); Xiaoyu Zhang, Hefei (CN); Yaping Zhang, Hefei (CN); Naihong Ding, Hefei (CN); Wenzheng Li, Hefei (CN); Yanyan Li, Hefei (CN); Mingjing Guan, Hefei (CN); Huijuan Tian, Hefei (CN)

(21) Appl. No.: 18/332,510

(22) Filed: Jun. 9, 2023

(30) Foreign Application Priority Data
Mar. 14, 2022 (CN) 202210245399.4

(51) Int. Cl. C09D 5/24; C09D 7/61; C09D 7/40; C09D 7/65; C09D 101/02; C09D 1/00; A24F 40/46; A24F 40/70; H05B 3/14

(52) U.S. Cl. CPC C09D 5/24; C09D 7/61; C09D 7/67; C09D 7/65; C09D 101/02; C09D 1/00; A24F 40/46; A24F 40/70; H05B 3/145; H05B 2214/04; H05B 2203/017; H05B 2203/032

(57) ABSTRACT

The present disclosure discloses an infrared radiation slurry and an infrared radiation heating element based on the infrared radiation slurry. Raw materials of the infrared radiation slurry include high infrared radiance materials, a conductive material and a substrate adhesive. The raw materials are evenly mixed, coated on a quartz glass tube, and carbonized to obtain the infrared radiation heating element. The present disclosure utilizes the compounded infrared radiation slurry to form a coating on a glass substrate with uniform components, uniform and controllable resistance, high conversion efficiency of electrothermal radiation, and strong adhesion, thereby achieving excellent performance of the obtained infrared radiation heating element.

### TECHNICAL FIELD

The present disclosure relates to the technical field of novel tobacco products, and in particular to an infrared radiation slurry for a tobacco heating device and an infrared radiation heating element based on it.

### BACKGROUND

With more and more attention paid to physical health, it is imperative to develop new types of tobacco products. A low-temperature heated type of tobacco product is one of important categories of new tobacco products, generally delivers satisfaction and some of tobacco flavor to consumers in manner of heat-not-burn tobacco, and is similar to traditional tobacco products in appearance and consumption mode, meeting consumers' needs to a certain extent.

A heated tobacco product usually consists of a heating smoking device and a tobacco capsule. At present, commercially available products are mainly electric heating smoking devices, including sheet type electric heating elements with IQOS as a representative and needle type electric heating elements with China Tobacco Hubei Industrial LLC's products as a representative, both of which use a principle of electric heating to heat the tobacco material. However, the tobacco material is in direct contact with a heating element, and after heating, the tobacco material will adhere to the heating element due to carbonization and coking, causing contamination of the heating element, reducing heating efficiency, and affecting consumer's experience, and meanwhile a heat transfer method from inside to outside causes uneven heating inside and outside the tobacco material, reducing raw material utilization rate and sensory quality. Infrared radiation heating smoking device uses a principle of infrared heating to conduct penetrating heating on the tobacco material, and the tobacco material is evenly heated inside and outside, with better sensory quality and higher raw material utilization rate, and at the same time, while avoiding direct contact between the heating element and the tobacco material, without need to clean.

Infrared radiation slurry is one of core materials for an infrared radiation heating smoking device, and plays a decisive role in the heating of the tobacco material. Infrared radiation slurry usually includes an infrared radiation material and other functional components. According to usage environment, the functional components may include conductive materials, binders, sintering aids, and the like. The infrared radiation material is heated by conductive layers or other heat source to excite infrared rays of the infrared radiation material in a specific wave band, so as to heat an object to be heated. At present, the conductive layers used are mainly Ag, graphene, and the like, which have a high cost. Moreover, after high-temperature sintering, distribution of the components is not uniform, resulting in uneven heating of the tobacco material.

### SUMMARY

An object of the present disclosure is to overcome shortcomings of the prior art and provide an infrared radiation slurry for a tobacco heating device and an infrared radiation heating element based on the same, with an aim to form a coating on a glass substrate with uniform components, controllable resistance, high conversion efficiency of electrothermal radiation, and strong adhesion.

To achieve the object, the present disclosure adopts the following technical solutions.

The present disclosure first discloses an infrared radiation slurry, which includes following raw materials in mass percentage:

a high infrared radiance material: 30-75%, a conductive material: 20-55%, and a substrate adhesive: 5-30%.

Further, the high infrared radiance material is at least two of graphene, nano nickel ferrite, nano manganese ferrite, nano zinc ferrite, nano iron oxide, nano titanium oxide and nano tin oxide.

Further, the conductive material is a high-temperature carbonizable biological substrate, preferably at least one of cyclodextrin, maltodextrin, phenolic resin, microcrystalline cellulose and lignin.

Further, the substrate adhesive is at least one of water glass and silica sol.

The present disclosure also discloses an infrared radiation heating element, on which an infrared radiation coating is formed using the above infrared radiation slurry.

A method for preparing the infrared radiation heating element according to the present disclosure includes the following steps:
step 1: adding deionized water to a mixture of a high infrared radiance material, a conductive material and a substrate adhesive, and mixing evenly so as to prepare an infrared radiation slurry;
step 2: applying the infrared radiation slurry onto a quartz glass tube (inner wall and/or outer wall, set as needed; both inner wall and outer wall may be used, and the outer wall is optimal), which is then placed in a carbonization furnace for carbonization, such that the infrared radiation slurry is shaped into an infrared radiation coating, to obtain the infrared radiation heating element.

Further, the step 1 is specifically as below:
placing the high infrared radiance material, the conductive material and the substrate adhesive into a ball mill tank, adding deionized water and ball mill beads to perform ball milling and mix well, to obtain the infrared radiation slurry; or
first, adding an appropriate amount of deionized water into the high infrared radiance material and uniformly dispersing them by ultrasound to obtain a suspension; adding deionized water into the conductive material and the subtract adhesive and uniformly dispersing them by ultrasound; then, dropwise adding the suspension while ultrasound is applied and after the addition is completed, adding them into the ball mill tank to mix evenly, so as to obtain the infrared radiation slurry.

Further, in step 1, an addition amount of the deionized water accounts for 1-3 times the total mass of the high infrared radiance material, the conductive layer material and the substrate adhesive.

Further, in step 2, conditions for the carbonization are as follows: in a first stage, raising temperature to 150° C. at a heating rate of 3-10° C./min, and maintaining the temperature for 10-20 minutes; in a second stage, raising the temperature to 280-320° C. at a heating rate of 5-20° C./min, and maintaining the temperature for 5-10 minutes; in a third stage, raising the temperature to 600-1000° C. at a heating rate of 10-30° C./min, and maintaining the temperature for 0.5-5 hours; after the carbonization, cooling the infrared radiation heating element inside the furnace, and taking it out.

The infrared radiation heating element prepared by the above method is placed in the tobacco heating device to effectively heat the tobacco material, and the conversion efficiency of electrothermal radiation may reach 60-85%.

Compared with the prior art, the beneficial effects of the present disclosure are reflected in that:

1. In the infrared radiation slurry of the present disclosure, a cheap biomass polymer material that can be pyrolyzed to carbon at high temperature is used to generate a graphite layer with high electrical conductivity through pyrolysis. At the same time, the high infrared radiance material, which is evenly dispersed in the polymer material, is uniformly distributed on the graphite layer after carbonization, and the substrate adhesive further improves adhesion between the coating and the substrate. This composite material has excellent infrared radiation performance and conductivity, and is used in a tobacco heating device to effectively heat the tobacco material. The high infrared radiance material is evenly distributed on the graphite layer, which can heat the tobacco material more evenly, and has higher efficiency of infrared electrothermal radiation.

2. In the present disclosure, by compounding the high infrared radiance material, the conductive layer material and the substrate adhesive, it is possible to form a coating with uniform components, uniform and controllable resistance, high electrothermal radiation conversion efficiency and strong adhesion on the glass substrate, so that the infrared radiation heating element obtained has excellent performance.

3. The raw materials used in the present disclosure is cheap and easy to prepare, which can significantly reduce production cost and facilitate industrial production.

### BRIEF DESCRIPTION OF DRAWINGS

FIG. 1 shows resistance values of sections of infrared radiation heating elements made of infrared radiation slurries prepared according to examples.

### DESCRIPTION OF EMBODIMENTS

The following provides a detailed explanation of the examples of the present disclosure. The examples are implemented based on the technical solutions of the present disclosure, and provide detailed implementation methods and specific operation processes. However, the scope of protection of the present disclosure is not limited to the following examples.

### Example 1

The infrared radiation heating element of this example is prepared as follows:

Step 1: weighing 12% of graphene, 20% of nano manganese ferrite, 18% of nano tin oxide, 22% of microcrystalline cellulose, 10% of cyclodextrin, 10% of water glass and 8% of silica sol respectively in mass percentage, mixing them together, placing them in a ball mill tank, adding deionized water in an amount of 1.3 times the total mass of the above raw materials and 30 g of ball mill beads, and then ball milling them for 1.5 hours to obtain an infrared radiation slurry.

Step 2: applying the infrared radiation slurry to an outer wall of a cylindrical quartz glass tube, placing the cylindrical quartz glass tube in a carbonization furnace for carbonization, so that the infrared radiation slurry is shaped into an infrared radiation coating layer, i.e., obtaining an infrared radiation heating element. The conditions for the carbonization are as follows: in a first stage, raising temperature to 150° C. at a heating rate of 5° C./min, and maintaining the temperature for 10 minutes; in a second stage, raising the temperature to 290° C. at a heating rate of 15° C./min, and maintaining the temperature for 5 minutes; in a third stage, raising the temperature to 850° C. at a heating rate of 30° C./min, and maintaining the temperature for 2 hours; after the carbonization, cooling the infrared radiation heating element inside the furnace, and taking it out.

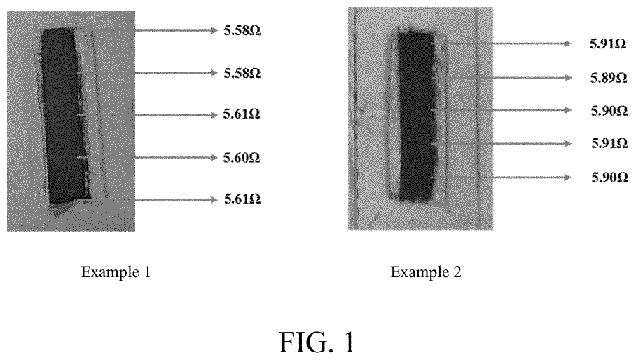

After the infrared radiation heating element is prepared and obtained using the slurry, the infrared radiation heating element is placed in the tobacco heating device to heat the tobacco material. When smoking with the above tobacco heating device, a larger amount of smoke and more adequate strength are produced. The conversion efficiency of electrothermal radiation of the heating element is 68% (national standard is 50%) as shown in Table 1, indicating high heating efficiency of infrared heating. The distribution of resistance values of sections of the heating element is shown in FIG. 1, and the distribution of resistance values is uniform.

### Example 2

The infrared radiation heating element of this example is prepared as follows:

Step 1: weighing 20% of graphene, 10% of nano ferric oxide, 15% of nano zinc ferrite and 5% of nano titanium oxide respectively in mass percentage, adding an appropriate amount of deionized water and uniformly dispersing them by ultrasound to obtain a suspension; 28% of microcrystalline cellulose, 10% of water glass, 12% of silica sol and deionized water in an amount of 1 time the total mass of the above raw materials, and dispersing uniformly by ultrasound, and then dripping the suspension while ultrasound is applied, and after the dripping is completed, adding them into the ball mill tank, and adding 30 g of ball mill beads for ball-milling for 2 hours, so as to obtain an infrared radiation slurry.

Step 2: applying the infrared radiation slurry to an outer wall of a cylindrical quartz glass tube, placing the cylindrical quartz glass tube in a carbonization furnace for carbonization, so that the infrared radiation slurry is shaped into an infrared radiation coating layer, i.e., obtaining an infrared radiation heating element. The conditions for the carbonization are as follows: in a first stage, raising temperature to 150° C. at a heating rate of 3° C./min, and maintaining the temperature for 15 minutes; in a second stage, raising the temperature to 290° C. at a heating rate of 15° C./min, and maintaining the temperature for 10 minutes; in a third stage, raising the temperature to 950° C. at a heating rate of 30° C./min, and maintaining the temperature for 2 hours; after the carbonization, cooling the infrared radiation heating element inside the furnace, and taking it out.

After the infrared radiation heating element is prepared and obtained using the slurry, the infrared radiation heating element is placed in the tobacco heating device to heat the tobacco material. When smoking with the above tobacco heating device, a larger amount of smoke and more adequate strength are produced. The conversion efficiency of electrothermal radiation of the heating element is 73% (national standard is 50%), as shown in Table 1, indicating high heating efficiency of infrared heating. The distribution of resistance values in sections of the heating element is as shown in FIG. 1, and the distribution of resistance values is uniform.

TABLE 1
conversion efficiency of electrothermal radiation
and average resistance value for infrared radiation
heating elements obtained from examples

| | Conversion efficiency of | Average resistance |
|---|---|---|
| Sample No. | electrothermal radiation | value (Ω) |
| Example 1 | 68% | 5.60 |
| Example 2 | 73% | 5.90 |

What is claimed is:

1. An infrared radiation slurry, comprising the following raw materials in mass percentage:
a high infrared radiance material: 30-75%, a conductive material: 20-55%, and a substrate adhesive: 5-30%.

2. The infrared radiation slurry according to claim 1, wherein the high infrared radiance material is at least two of graphene, nano nickel ferrite, nano manganese ferrite, nano zinc ferrite, nano iron oxide, nano titanium oxide and nano tin oxide.

3. The infrared radiation slurry according to claim 1, wherein the conductive material is a high-temperature carbonizable biological substrate.

4. The infrared radiation slurry according to claim 3, wherein the conductive material is at least one of cyclodextrin, maltodextrin, phenolic resin, microcrystalline cellulose and lignin.

5. The infrared radiation slurry according to claim 1, wherein the substrate adhesive is at least one of water glass and silica sol.

6. An infrared radiation heating element, wherein an infrared radiation coating is formed on the infrared radiation heating element using the infrared radiation slurry according to claim 1.

7. The infrared radiation heating element according to claim 6, wherein the high infrared radiance material is at least two of graphene, nano nickel ferrite, nano manganese ferrite, nano zinc ferrite, nano iron oxide, nano titanium oxide and nano tin oxide.

8. The infrared radiation heating element according to claim 6, wherein the conductive material is a high-temperature carbonizable biological substrate.

9. The infrared radiation heating element according to claim 8, wherein the conductive material is at least one of cyclodextrin, maltodextrin, phenolic resin, microcrystalline cellulose and lignin.

10. The infrared radiation heating element according to claim 6, wherein the substrate adhesive is at least one of water glass and silica sol.

11. A method for preparing the infrared radiation heating element according to claim 6, wherein the method comprises following steps:
step 1: adding deionized water to a mixture of the high infrared radiance material, the conductive material and the substrate adhesive and mixing them evenly to prepare the infrared radiation slurry;
step 2: applying the infrared radiation slurry onto a quartz glass tube, placing the quartz glass tube in a carbonization furnace for carbonization, such that the infrared radiation slurry is shaped into the infrared radiation coating, to obtain the infrared radiation heating element.

12. The method according to claim 11, wherein specific method of step 1 is:
placing the high infrared radiance materials, the conductive material and the substrate adhesive in a ball mill tank, adding deionized water and ball mill beads to mix evenly to obtain the infrared radiation slurry; or
first, adding appropriate amount of deionized water into the high infrared radiance materials and uniformly dispersing it by ultrasound to obtain suspension; adding deionized water into the conductive material and the subtract adhesive and uniformly dispersing it by ultrasound; then, dropwise dripping the suspension while ultrasound is applied. After the dripping is completed, adding it into the ball mill tank to mix evenly, so as to obtain the infrared radiation slurry.

13. The method according to claim 11, wherein in step 1, an addition amount of the deionized water accounts for 1-3 times of the total mass of the high infrared radiance materials, the conductive layer material and the substrate adhesive.

14. The method according to claim 12, wherein in step 1, an addition amount of the deionized water accounts for 1-3 times of the total mass of the high infrared radiance materials, the conductive layer material and the substrate adhesive.

15. The method according to claim 11, wherein in step 2, conditions for the carbonization are: in a first stage, raising temperature to 150° C. at a heating rate of 3-10° C./min, and maintaining the temperature for 10-20 minutes; in a second stage, raising the temperature at a heating rate of 5-20° C./min to 280-320° C., and maintaining the temperature for 5-10 minutes; in a third stage, raising the temperature to 600-1000° C. at a heating rate of 10-30° C./min, and maintaining the temperature for 0.5-5 hours; after carbonization, cooling the infrared radiation heating element inside the furnace and taking out the infrared radiation heating element.
